(19) United States
(12) Patent Application Publication
(10) Pub. No.: US 2012/0015118 A1
(43) Pub. Date: Jan. 19, 2012

(54) METHOD AND DEVICE FOR CONTROLLING THE COLOR OF METALS

(75) Inventors: Nikolay I. Zheludev, Southampton (GB); Kevin Francis MacDonald, Southampton (GB); Nikitas Papasimakis, Southampton (GB); Jianfa Zhang, Southampton (GB); Jun-Yu Ou, Southampton (GB)

(73) Assignee: University of Southampton

(21) Appl. No.: 13/182,084

(22) Filed: Jul. 13, 2011

(30) Foreign Application Priority Data
Jul. 13, 2010 (GB) GB 1011720.8

(51) Int. Cl. B44F 1/08; C23F 1/04; B44F 1/12; B23K 26/00; B32B 3/30; B32B 15/00; B05D 5/06; B21B 23/00

(52) U.S. Cl. 428/29; 427/162; 216/24; 72/365.2; 219/121.6; 428/156; 428/574; 428/546

(57) ABSTRACT

A method and a device are disclosed for changing the color of a metal surface in a given part of the electromagnetic spectrum. It is achieved by creating a surface relief as an array of raised or indented repeated elements without breaking the continuity of the metal surface. The characteristic size of the elements is smaller than the shortest wavelength in that part of spectrum. In particular, the method uses excitation of surface plasmons on the metal surface. The relief may be optionally covered by a layer of dielectric or semiconductor for further fixed or externally controlled change of the metal surface color. The device may be used to detect the intensity or color or phase of incident light. It may be used to detect another substance in proximity of the surface by changing the color or phase or intensity of reflected light.

### CROSS-REFERENCE TO RELATED APPLICATIONS

This application claims priority of GB application GB 1011720.8 filed Jul. 13, 2010.

### FIELD OF INVENTION

This invention relates generally to fabrication of metal surfaces and provides a mechanism for dramatically changing and controlling the color of such surfaces by creating ‘bas-relief’ (raised) or ‘intaglio’ (indented without perforation) sub-wavelength metamaterial patterns on pure metal surfaces.

### BACKGROUND OF THE INVENTION

The appearance of any surface is determined by its properties of reflection, transmission, and absorption in the visible part of the spectrum. The majority of pure metals exhibit a characteristic shininess because, with plasma frequencies in the ultraviolet domain, their valence electrons are able to absorb and re-emit photons over the entire visible wavelength range. Their reflection spectra are thus fairly flat and they have a ‘silver’ color. Gold and copper are obvious exceptions to this rule: with plasma frequencies lower than most metals they absorb light in the blue and blue/green parts of the spectrum and consequently appear yellow and red respectively to the human eye.

Techniques for changing the appearance (in particular the color) of metal surfaces typically rely on the application of coatings, such as paint and multilayer dielectrics, or controlled chemical modification, e.g. oxide formation by anodization.

We report here a new technique for the color change and control.

### SUMMARY OF THE INVENTION

A method for changing colors of a metal surface is proposed by creating ‘bas-relief’ (raised) or ‘intaglio’ (indented without perforation) sub-wavelength metamaterial patterns on pure metal surfaces, wherein the characteristic sizes of the pattern elements is sub-wavelength of said part of the spectrum. In particular, the color change is caused by excitation of surface plasmons on the metal surface. In addition, the surface may be covered by a protective layer of dielectric or semiconductor. The constitution or thickness of this protective layer is used to further change the perceived color of the metal.

Besides the color, the intensity and/or phase of reflected light may be changed relative to those of incident light. The reflected light intensity, color and/or phase may be changed via the application of electric or magnetic field, or heat, or intense electromagnetic or particle irradiation to the said layer of covering material.

This method may be implemented for detecting the presence of another substance in the proximity of said metal surface by detecting a variation in the color, phase or intensity of the reflected light. The method may be used to suppress or enhance the reflectivity of the said surface.

Another object of the present invention is a device, comprising: a metal surface with an array of repeated raised or indented relief elements created on the surface without breaking its continuity, wherein the characteristic sizes of the elements is sub-wavelength. Each element may be a split ring, split oval or split polygon. Alternatively, each element may be at least one closed ring, oval or polygon. In yet another embodiment, each element may comprise crossed or uncrossed bar structures. In yet another embodiment, each element may comprise curved line elements.

The metal surface may be made of gold, silver, copper, aluminum, platinum, rhodium, iridium, zinc or alloys containing them.

In another embodiment, the device has an additional layer of another material used to detect the intensity, color or phase of the incident light via the monitoring of voltage across said additional layer or current in said additional layer. This additional layer may be a layer of liquid crystal, organic material, photochromic material, structured carbon, chalcogenide glass, transparent conductive oxide or semiconductor.

The relief on the device surface is created by casting, embossing, imprinting, ion beam milling, etching, optical or electron beam lithography, template stripping, laser irradiation or a combination of these. Alternatively, it may be created by self-assembly of metal participles on a metal surface.

The device is used for providing security marks on documents and products. It also may be used for providing change of color or creation of color patterns on documents and products. It also may be used to change the color of metal flakes mixed into paint.

### DESCRIPTION OF THE DRAWINGS

FIG. 1: (a) Artistic impressions of bas-relief and intaglio split-ring metamaterial patterned surfaces; (b) Asymmetric split-ring repeated element (unit cell) geometry used in experimental aluminum bas-relief and gold intaglio samples; (c) Electron microscope image of a gold intaglio patterned metamaterial surface.

FIG. 2: Reflectivity, relative to the corresponding unstructured metal surface of (a) aluminum bas-relief and (b) gold intaglio surfaces patterned with square arrays of raised [bas-relief, 70 nm high] and indented [intaglio, 150 nm depth] asymmetric split-rings [375 nm unit cell, as shown in FIG. 1b]. Data for two orthogonal polarizations of incident light [x and y as defined in FIG. 1b] are presented. The insets show optical microscope images of the samples, illustrating the difference in color between structured and unstructured surfaces of the metals.

FIG. 3: Controlling the color of gold using bas-relief and intaglio metamaterial surface structures. Numerically simulated color (labeled with corresponding co-ordinates based on the CIE 1931 chromaticity standard, assuming 6500 K black-body illumination) of a gold surface patterned with arrays of geometrically different unit cells (as shown in plan view): (a) 70 nm deep intaglio asymmetric split-rings [polarization-dependent color]; (b) 70 nm high bas-relief and 70 nm deep intaglio concentric rings [polarization independent]; (c) 90 nm deep intaglio concentric squares. The color of unstructured gold is shown above for reference.

FIG. 4: Illustrative examples of possible meta-molecule repeat element/unit-cell) designs in plan view. Shaded regions may be raised above or indented below the surrounding surface. Dashed lines denote the boundary of the unit cell.

FIG. 5: Further illustrative examples of possible meta-molecule (repeat element/unit-cell) designs in plan view. Shaded regions may be raised above or indented below the surrounding surface.

FIG. 6: Example aesthetic application of intaglio/bas-relief metamaterials 10—expanded detail) for the production of novel color effects in metallic components of a wristwatch display (11).

FIG. 7: Example aesthetic application of intaglio/bas-relief metamaterials (12—expanded detail) for the production of novel color effects in metallic components of jewelry (13,14).

FIG. 8: Example aesthetic and security applications of intaglio/bas-relief metamaterials (15—expanded detail) for the production of novel color effects in metallic display components (16) or security features (17) on consumer electronic items.

FIG. 9: Example security application of intaglio/bas-relief metamaterials (18—expanded detail) in anti-forgery features (19) on banknotes.

FIG. 10: Example aesthetic applications of intaglio/bas-relief metamaterials 20—expanded detail) for the production of novel color effects in automotive bodywork (21) or internal detailing (22).

FIG. 11: Example application of intaglio/bas-relief metamaterials (23—expanded detail) for the production of novel color effects in paint (24) via the dispersion of patterned metallic flakes.

FIG. 12: Example device application of intaglio/bas-relief metamaterials to optical sensing. The metamaterial surface (25—in cross-section) is coated with a photosensitive medium (26). By monitoring the voltage or resistance across this layer or the current through it [via a transparent conductive electrode layer (27) and appropriate signal meter (28)] one may detect changes in the intensity, color or phase of incident light (29).

FIG. 13: Example device application of intaglio/bas-relief metamaterials to optical modulation. The metamaterial surface (25—in cross-section) is coated with an electro-active medium (26). By applying a voltage across or current through this layer [via a transparent conductive electrode layer (27) and appropriate power source (30)] one may change its optical properties and thereby modulate the intensity, color or phase of incident light (29) reflected from the device.

FIG. 14: Example device application of intaglio/bas-relief metamaterials to (bio)chemical sensing: One may detect the presence of a material (31) on the metamaterial surface (25—in cross-section) by monitoring the intensity, color or phase of incident light (32) reflected from the device. These characteristics will differ for light reflected from metamaterial surface areas with (33) and without (34) analyte material present and in the former case will depend on the chemical composition and thickness of this material.

### DETAILED DESCRIPTION OF THE PREFERRED EMBODIMENT

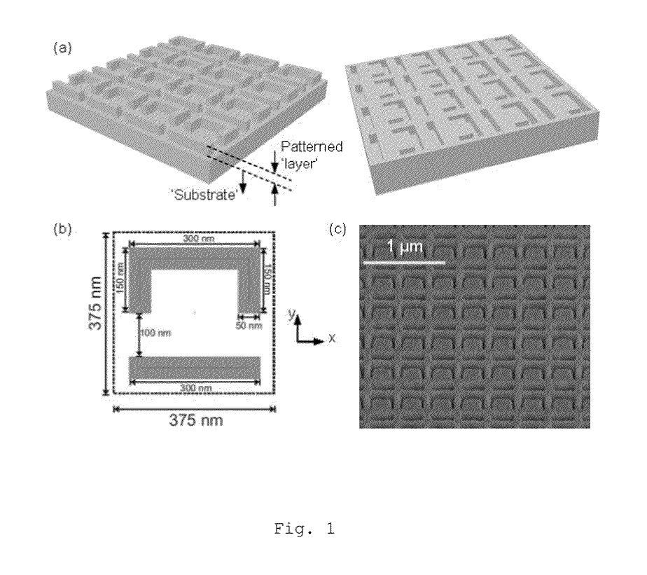

We propose the fabrication of ‘bas-relief’ (raised) or ‘intaglio’ (indented without perforation) sub-wavelength metamaterial patterns on a metal surface, such as illustrated in FIG. 1, which provide a mechanism for changing and controlling the color of such surfaces whilst retaining other metallic properties (e.g. lustre, smoothness, hardness, electrical conductivity, chemical properties) that may be lost in the use of materially different coatings. ‘Structural colors’ are found throughout the biological world: many plants and animals display dramatic colors that are derived from astonishingly complex three-dimensional assemblies of intrinsically colorless bio-materials [see, for example, A. R. Parker, “515 million years of structural color,” J. Opt. A: Pure Appl. Opt. 2, R15-R28(2000)]. Bas-relief and intaglio designs employ metamaterial concepts to bring structural color to metals, allowing, for example, pure gold to appear green. Rather than diffraction or scattering effects, their functionalities rely on the individual and collective plasmonic resonances of the meta-molecules (repeated ‘unit-cell’ elements), which in turn are functions of pattern geometry and relief height or indentation depth.

In the broadest sense, metamaterials are artificial media structured on a scale smaller than the wavelength of external stimuli (thereby excluding diffraction effects) to provide a response to such stimuli that cannot be achieved using natural materials [see, for example, E. Ozbay, “The magical world of photonic metamaterials,” Opt. Phot. News 19, 22-27 (2008); and N. I. Zheludev (one of the inventors), “The Road Ahead for Metamaterials,” Science 328, 582-583 (2010)]. They have been the subject of intense research interest in recent years and have been engineered to provide a range of novel photonic functionalities from negative refraction to ‘invisibility’. So-called ‘planar’ or ‘two-dimensional’ metamaterials conventionally consist of numerous, nominally identical, resonant sub-wavelength metallic structures ('meta-molecules') arranged on a dielectric substrate, or conversely of meta-molecule voids cut through a metallic thin film. Their functionality relies on the existence of discontinuities in the metallic structure as seen by incident electromagnetic radiation.

The meta-surfaces described here are distinctly different from these forms in that the patterned metal ‘layer’ of bas-relief and intaglio structures sits directly on a continuous ‘substrate’ of the same metal. As such they present a continuous metal mirror surface to incident light. Nevertheless, they are found experimentally to display resonant optical properties which, like those of conventional metamaterial structures, depend on the geometric form and physical size of the meta-molecule unit cell.

Aluminum bas-relief metamaterial structures were fabricated at an interface between the metal and an optically polished fused silica substrate using electron beam lithography and anisotropic reactive ion etching: Split-ring patterns (500×500 μm arrays with a square unit cell size of 375 nm, as shown in FIG. 1b) were etched into the silica to a nominal depth of 70 nm; The substrate was then coated by evaporation with a 250 nm layer of aluminum to form a metallic meta-surface of high optical quality.

Gold intaglio metamaterial patterns were fabricated by focused ion beam milling: Split-ring patterns (20×20 μm arrays with square unit cell sizes of 375 nm) were milled to a depth of 150 nm into a 200 nm evaporated gold film on a glass substrate (FIG. 1c).

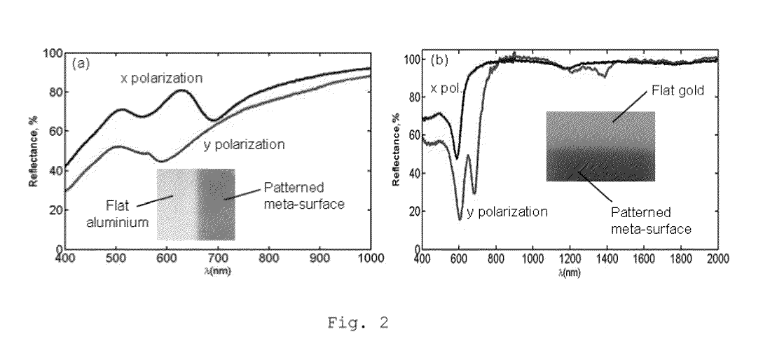

Reflection characteristics of the meta-surfaces were quantified at normal incidence as a function of wavelength and polarization using a microspectrophotometer. FIG. 2a shows the reflectivity of an aluminum/silica bas-relief meta-surface with a unit cell size of 375 nm, relative to that of an unstructured aluminum/silica interface, for incident polarizations parallel (x) and perpendicular (y) to the split in the meta-molecule. One sees a dramatic reduction in reflectivity at the blue end of the visible spectrum for both polarizations and marked dips at other polarization-dependent wavelengths. As a consequence, the color of the patterned surface is substantially different from that of unstructured aluminum: e.g. under an optical microscope illuminated by a halogen light source, a metal that ‘naturally’ appears silver/grey, becomes green (see inset to FIG. 2a).

FIG. 2b shows the reflectivity of a gold intaglio meta-surface with a unit cell size of 375 nm (electron microscope image inset), again relative to that of the unstructured metal surface for incident polarizations parallel (x) and perpendicular (y) to the split in the meta-molecule. Here once more, reflectivity is suppressed at the blue end of the visible range for both polarizations and there are pronounced dips at other polarization-dependent wavelengths: a yellow metal this time is turned green via sub-wavelength surface patterning.

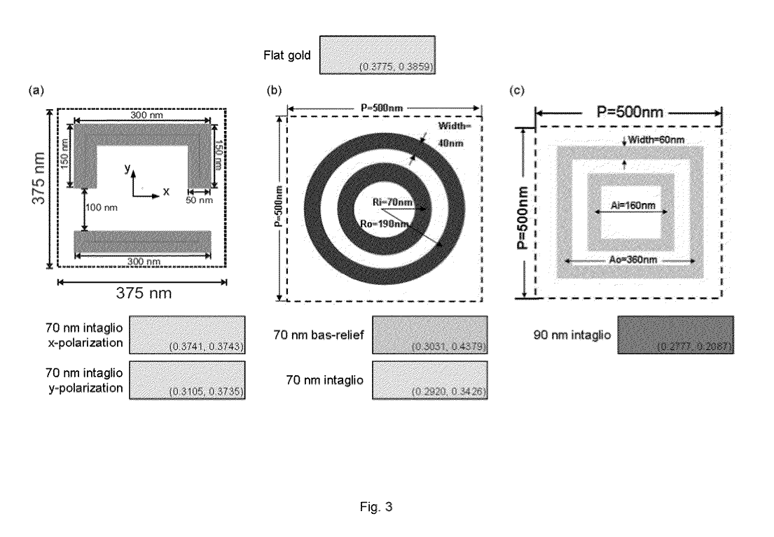

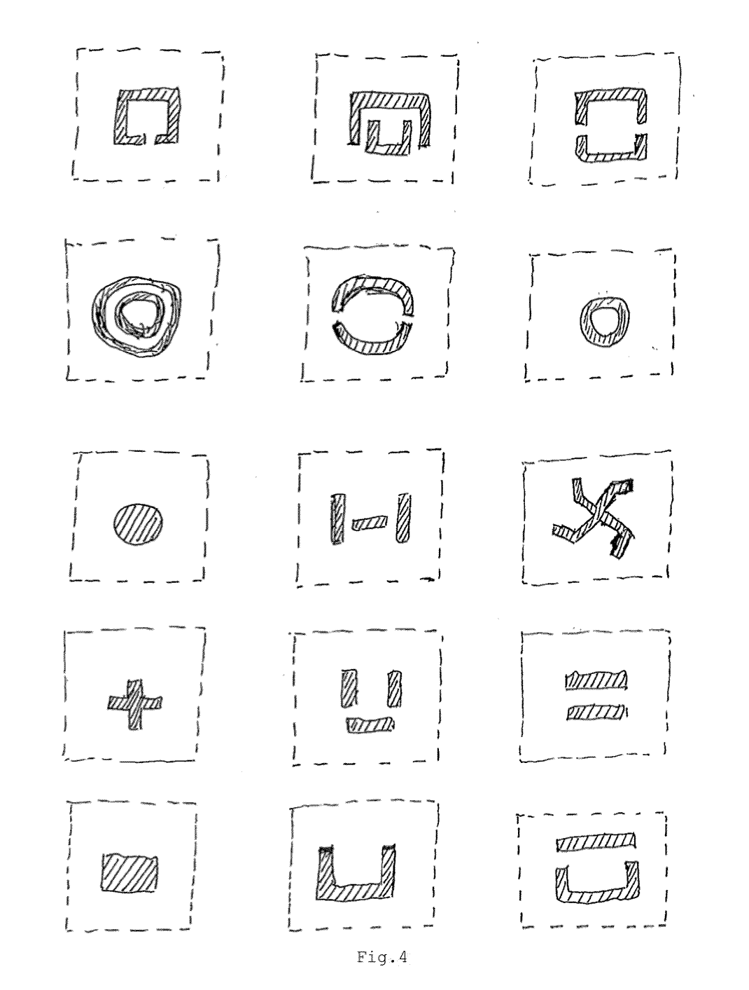

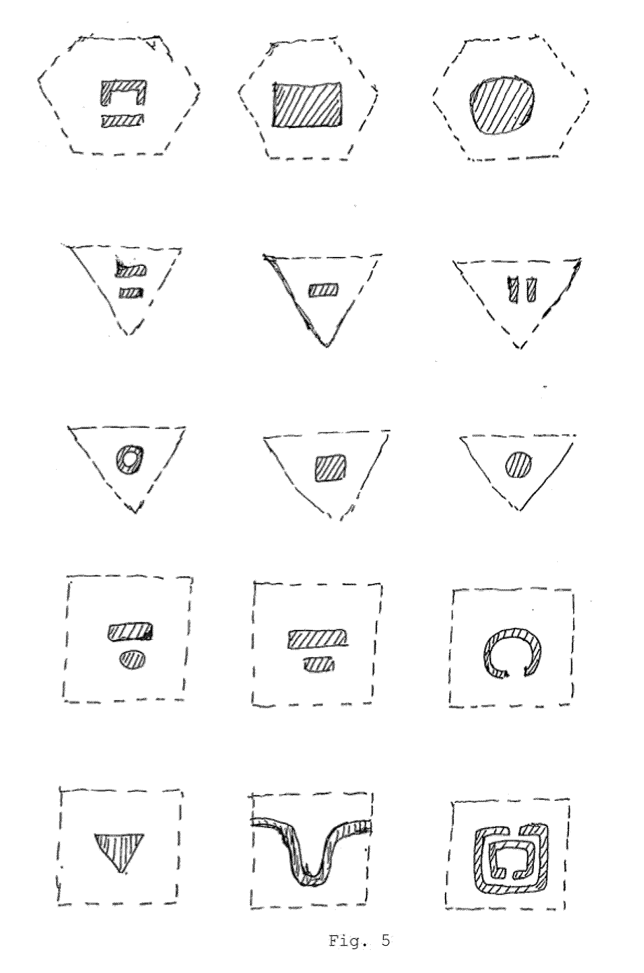

A full palette of colors may be tailored to requirement by varying the geometry of metamaterial patterns applied to a metal surface. For example, the numerical simulations presented in FIG. 3 illustrate how a gold surface may be engineered to produce a range of different colors. FIGS. 4 and 5 show further examples of possible meta-molecule patterns.

The structures analyzed here, and those studied in experiment, comprise regular square arrays of meta-molecules but similar (or indeed more complex) structurally engineered optical properties may equally be achieved in any arrangement, e.g. random, fractal, quasi-periodic.

The bas-relief and intaglio concepts may be extended far beyond the visible range into the infra-red, terahertz and microwave parts of the spectrum, in which case the term ‘color’, used above in its standard context of human visual perception, would be defined more broadly as equivalent to ‘reflection spectrum’.

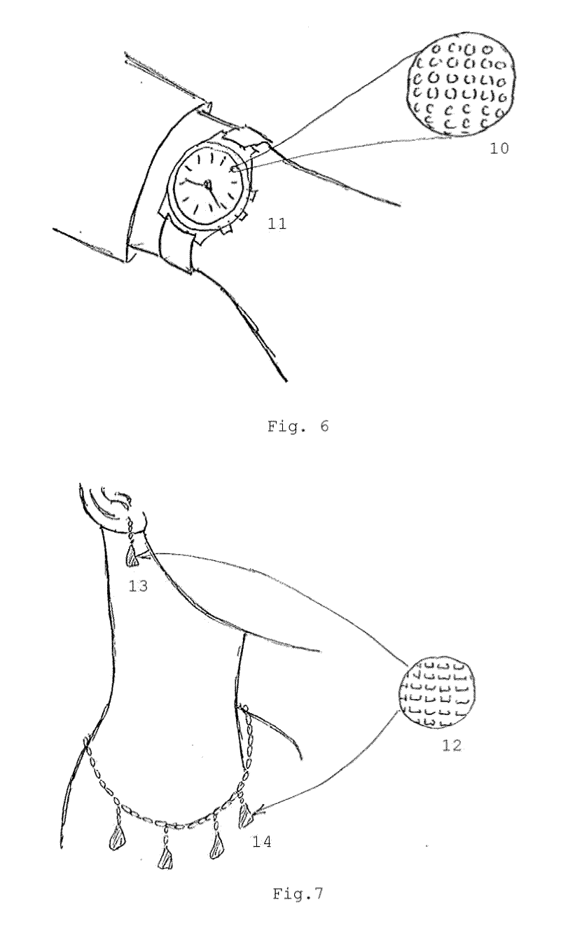

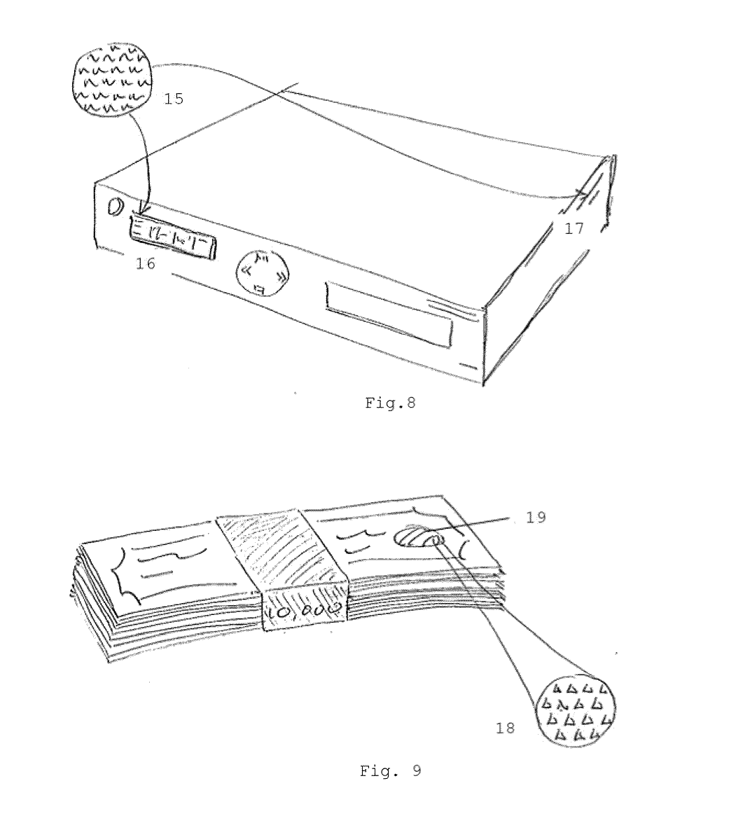

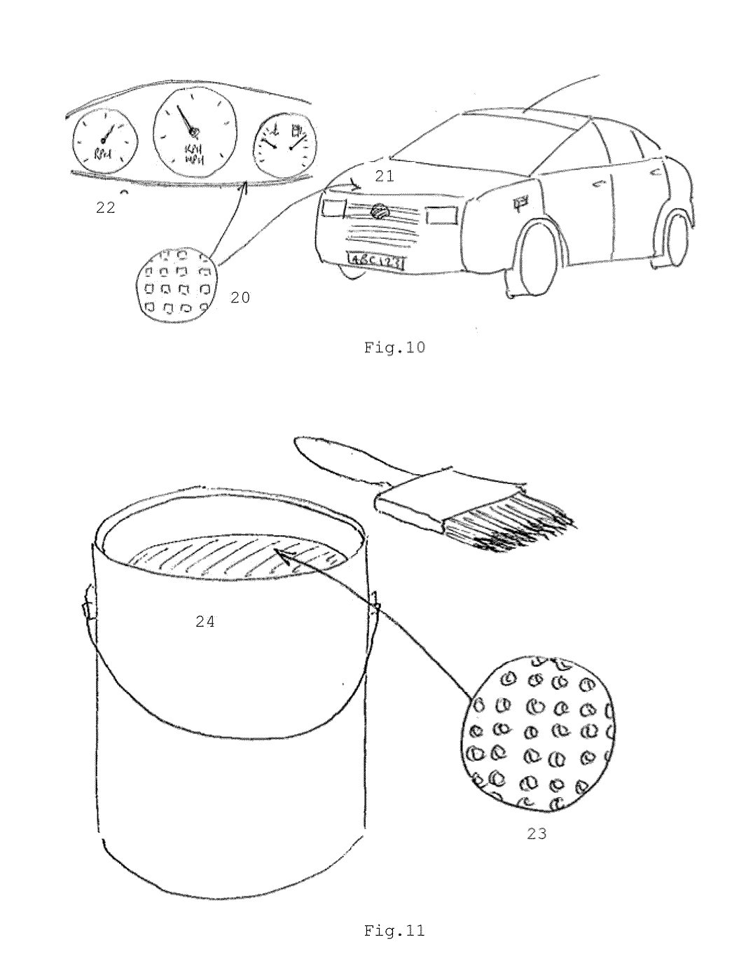

Metamaterial structures comprising two (or more) different media, must address issues such as chemical compatibility and mutual adhesion, and typically rely on complex fabrication processes (e.g. thin-film deposition, electron-beam lithography, anisotropic etching, focused ion beam milling) that demand planar substrates as a starting point. In effectively being composed of ‘patterned’ and ‘substrate’ layers of a single medium, metallic meta-surfaces may offer considerable advantages in ease of fabrication and application to bulk (as opposed to thin-film) media and/or non-planar surface profiles. The above mentioned techniques can be used but bas-relief and intaglio metamaterials may also be produced on a larger scale via simpler procedures such as nano-imprint and template stripping. Ultimately they may be fabricated with relatively minor adaptations to standard metal-forming process (e.g. pressing, rolling, casting) and thereby applied to anything from an item of jewelry to a piece of automotive bodywork or flakes of metal mixed into paint (FIGS. 6-11). At the same time, such structures may provide optical properties that are extremely difficult to imitate, thereby facilitating security applications (e.g. banknote anti-forgery features, FIG. 9) and providing high-value exclusivity in aesthetic applications.

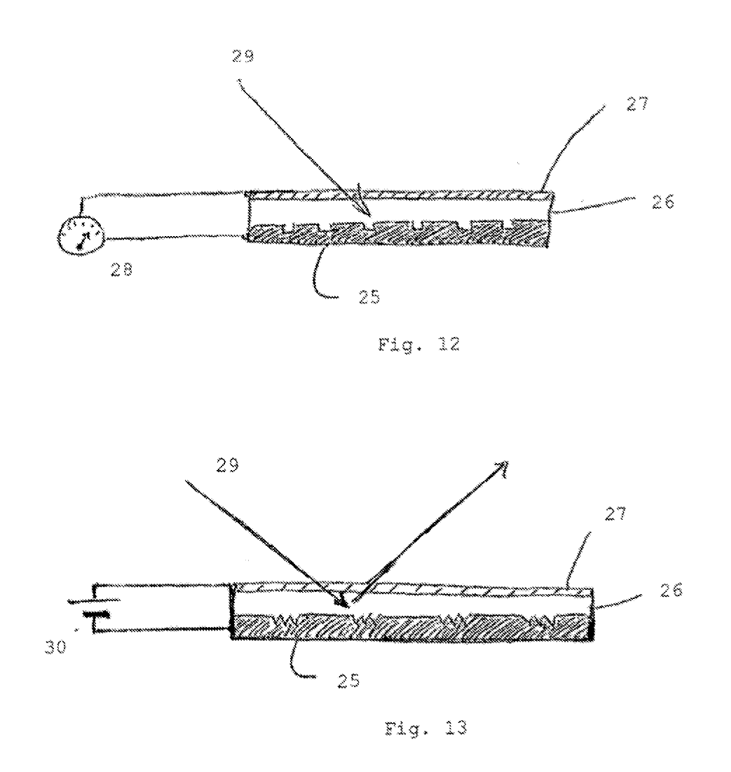

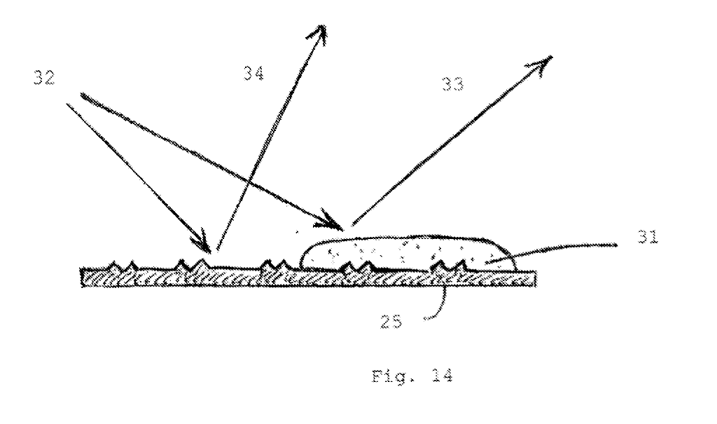

In any application, the spectral properties of bas-relief and intaglio metamaterials will be affected by a layer of dielectric placed on them. This offers opportunities for developing sensors, detectors and various forms of modulators of electromagnetic radiation exploiting reflective properties of bas-relief and intaglio metamaterials (FIGS. 12-14).

### DEFINITIONS

Color: In extension to common usage, where the term refers to human perception of visible electromagnetic radiation in categories called red, green, blue and others, here it is used to describe the spectrum of light in any domain of the electromagnetic continuum, including the infrared, terahertz and microwave spectral bands.

Array: A distribution of elements on a surface, which may be strictly periodic, quasi-periodic, multiply or partially periodic, fractal, or random.

Plasmon: A coupled oscillation of light and electrons of the metal which can be localized or propagating along a metal surface.

The description of the preferred embodiments of the invention has been presented for purposes of illustration and description. It is not intended to be exhaustive or to limit the invention to the precise form disclosed, and obviously many modifications and variations are possible in the light of the above teaching. The described embodiment was chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. A method for changing a color of a metal surface in a given part of the electromagnetic spectrum, comprising: creation on the surface of an array of repeated raised or indented relief elements without breaking the continuity of the metal surface, wherein
a characteristic size of the elements is sub-wavelength.

2. The method of claim 1, wherein the given part of spectrum is in a spectral range of radiation visible to a human eye.

3. The method of claim 2, wherein the color change is caused by excitation of surface plasmons on the metal surface.

4. The method of claim 1, further comprising: covering the surface with a layer of dielectric or semiconductor to further change the color of the surface.

5. The method of claim 4, wherein a constitution or a thickness of the layer is used to further change the color of the metal.

6. The method of claim 5, wherein an intensity or phase of the reflected light is changed compared to that of an incident light after reflection from the surface.

7. The method of claim 6, wherein the reflected light intensity, color and/or phase are changed via the application of electric or magnetic field, or heat, or intense electromagnetic or particle irradiation to said layer of covering material.

8. The method of claim 5, further comprising: detecting a presence of another substance in the proximity of said surface by detecting a variation in the color, phase or intensity of the reflected light.

9. The method of claim 1 used to suppress or enhance a reflectivity of said surface.

10. A device, comprising:
a surface with an array of repeated raised or indented relief elements created on the surface without breaking its continuity, wherein a characteristic size of the elements is sub-wavelength, wherein the array is used to create the surface color.

11. The device of claim 10, wherein each element is a split ring, split oval or split polygon.

12. The device of claim 10, wherein each element is at least one ring, oval or polygon.

13. The device of claim 10, wherein each element is a crossed or uncrossed bar structure.

14. The device of claim 10, wherein the array comprises curved line elements.

15. The device of claim 10, when the surface is metal surface made of gold, silver, copper, aluminum, platinum, rhodium, iridium, zinc or alloys containing them.

16. The device of claim 10, further comprising: an additional layer of another material used to detect an intensity, color or phase of the incident light via monitoring of voltage across said additional layer or current in said additional layer.

17. The device of claim 16, wherein the additional layer is a layer of liquid crystal, organic material, photochromic material, structured carbon, chalcogenide glass, transparent conductive oxide or semiconductor.

18. The device of claim 10, wherein the relief is created by casting, embossing, imprinting, ion beam milling, etching, optical or electron beam lithography, template stripping, laser irradiation or a combination of these.

19. The device of claim 10, wherein the relief is created by self-assembly of metal participles on the metal surface.

20. The device of claim 10 providing security marks on documents and products.

21. The device of claim 10 providing change of color or creation of color patterns on documents and products.

22. The device of claim 10 used to change the color of metal flakes mixed into paint.
